(19) United States
(12) Patent Application Publication
(10) Pub. No.: US 2008/0006613 A1
(43) Pub. Date: Jan. 10, 2008

(54) Short resistant welder

(76) Inventors: Mark Ulrich, New London, WI (US); Sean Moran, Neenah, WI (US); Kenneth C. Altekruse, Appleton, WI (US); Ben Newcomb, Rockford, MI (US)

Correspondence Address: FLETCHER YODER (ILLINOIS TOOL WORKS INC.), P.O. BOX 692289, HOUSTON, TX, 77269-2289, US

(21) Appl. No.: 11/484,145

(22) Filed: Jul. 10, 2006

(51) Int. Cl. B23K 9/20

(52) U.S. Cl. 219/98; 219/99

(57) ABSTRACT

A short resistant welder that includes, in some embodiments, a short circuit sensor configured to transmit a first signal indicative of a short circuit between a workpiece and a stud, and a stud welding controller communicatively coupled to the short circuit sensor. In certain embodiments, the stud welding controller is configured to transmit an increase-current control signal to a power supply in response to the first signal.

### BACKGROUND

The present invention relates generally to welding devices and, in certain embodiments to welding devices resistant to short circuits.

Electric welding systems typically employ an electrode and a current source to weld a workpiece. Generally, the workpiece is connected to a first lead of the current source and the electrode is connected to a second, differently charged lead of the current source. To initiate welding, the electrode is typically brought near the workpiece, and an electric arc is struck over an air gap between the electrode and the workpiece. The electric arc converts electric energy into thermal energy, which liquefies metal proximate the electrode. In some forms of welding, the electric arc also melts metal in the electrode, thereby consuming the electrode.

Unfortunately, short circuits may interrupt the welding process. During welding, liquid metal may occasionally splash and bridge the air gap between the electrode and the workpiece. This liquid metal bridge may form a short circuit and bind the electrode to the workpiece. Generally, the resistance of the liquid metal bridge is much less than the resistance of the air gap. As a result, current may short circuit through the bridge instead of arcing across the air gap, and the welding system may cease generating thermal energy. Typically, if the short circuit is not cleared and the arc rapidly restored, the liquid metal may freeze, potentially securing the electrode to the workpiece.

### BRIEF DESCRIPTION

The following discussion describes, in part, a short resistant welder that includes, in some embodiments, a short circuit sensor configured to transmit a first signal indicative of a short circuit between a workpiece and a stud, and a stud welding controller communicatively coupled to the short circuit sensor. In certain embodiments, the stud welding controller is configured to transmit an increase-current control signal to a power supply in response to the first signal.

### DRAWINGS

These and other features, aspects, and advantages of the present invention will become better understood when the following detailed description is read with reference to the accompanying drawings in which like characters represent like parts throughout the drawings, wherein:

FIG. 1 is perspective view of an exemplary welding system in accordance with an embodiment of the present technique;

FIG. 2 is a side view of an exemplary stud welding gun in accordance with an embodiment of the present technique;

FIGS. 3-6 are diagrammatical illustrations of an exemplary stud welding process in accordance with an embodiment of the present technique;

FIG. 7 is a diagrammatic representation of the exemplary welding system of FIG. 1 in accordance with an embodiment of the present technique;

FIG. 8 is a graph depicting welding current and source voltage traces during the operation of the exemplary welding system of FIG. 1 in accordance with an embodiment of the present technique;

FIG. 9 is a flowchart depicting an exemplary welding process in accordance with an embodiment of the present technique; and

FIG. 10 is a flowchart depicting another exemplary welding process in accordance with an embodiment of the present technique.

### DETAILED DESCRIPTION

As discussed in detail below, some of the embodiments of the present technique provide a method and apparatus for disrupting a short circuit (e.g., bridged metal) between an electrode and a workpiece. For example, certain embodiments described herein detect a short circuit and, in response, transmit a burst of substantially increased current. As is described below, a surge of greater current may disrupt the short circuit (e.g., bridged metal) and restore an electric arc. Of course, such embodiments are merely exemplary of the present technique, and the appended claims should not be viewed as limited to those embodiments. Indeed, the present technique is applicable to a wide variety of systems.

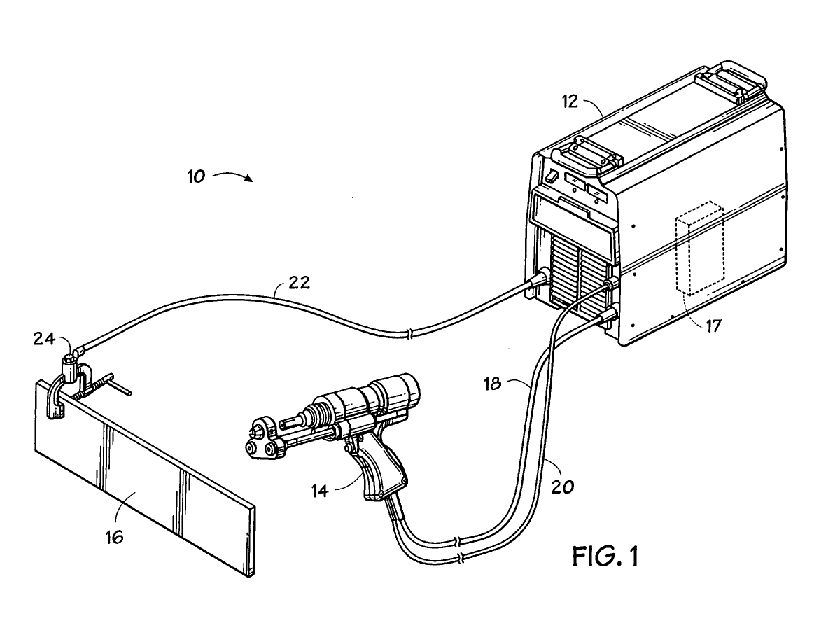

FIG. 1 depicts an exemplary welding system 10. The present exemplary welding system 10 includes a stud welding power control unit 12 (hereinafter “power control unit”), a stud welding gun 14, and a workpiece 16. As explained below, the power control unit 12, in some embodiments, may be configured to disrupt a short circuit (e.g., bridged metal) between the stud welding gun 14 and the workpiece 16. For example, the power control unit 12 may produce a surge, pulse, or temporary increase in current or another electrical parameter to the welding gun 14. By further example, a current surge may generally breakup or separate bridged metal between the workpiece 16 and the stud welding gun 14. The power control unit 12 may include components 17, such as a feedback controller, an inverter current regulator, a current sensor, a stud welding controller, a power supply, a voltage sensor, a short sensor, or a combination thereof, as described further below.

In the present embodiment, the exemplary welding system 10 also includes a weld cable 18, a control cable 20, a ground cable 22, and a clamp 24. While the present weld cable 18 and control cable 20 are depicted as separate cables, in some embodiments the cables 18 and 20 may be bundled or split into additional cables. Further, the welding system 10 may include an automatic stud loading system, an automatic stud welding gun positioning device, and a factory automation system configured to position the stud welding gun on a workpiece.

It should also be noted that, while the present welding system 10 is a stud welding system, other types of welding systems are within the scope of the present technique, such as electric arc welding systems, shielded metal arc welding systems, stick welding systems, metal inert gas welding systems, tungsten inert gas welding systems, plasma arc welding systems, plasma arc cutting systems, and/or submerged arc welding systems, for instance.

When the exemplary welding system 10 is assembled, the weld cable 18 and the control cable 20 may independently electrically couple the stud welding gun 14 to the power control unit 12. The power control unit 12 may electrically connect to the workpiece 16 through the ground cable 22, which may be removably coupled to the workpiece 16 by the clamp 24.

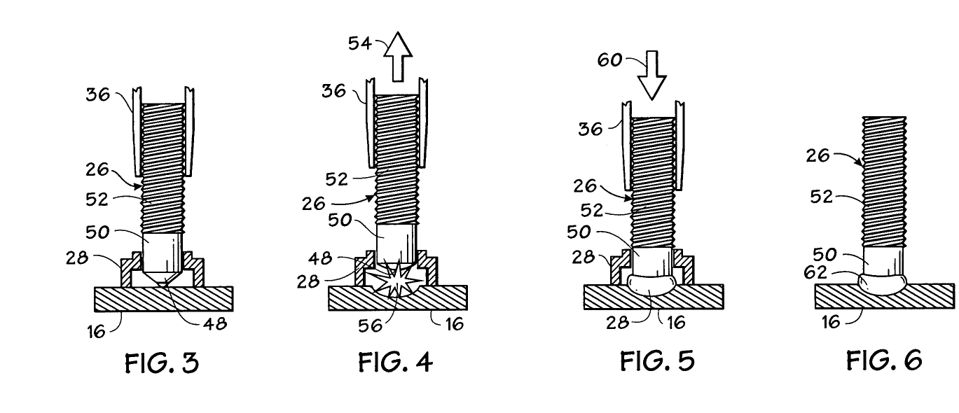

In operation, the welding system 10 may be used to weld a stud to the workpiece 16. As is explained below in reference to FIGS. 3-6, the stud welding gun 14 may position a stud a short distance from the workpiece 16, and the power control unit 12 may drive current through the stud. Current may flow from/to the power control unit 12 through the weld cable 18. The electric current may arc between the workpiece 16 and the stud, thereby melting metal in the stud and/or the workpiece 16. The ground cable 22 may conduct current between the workpiece 16 and the power control unit 12 through the clamp 24. Together, these components may complete the welding current circuit. As explained below, in some embodiments, if a short circuit is detected during welding, the power control unit 12 may output a burst of current to blow the short.

The control cable 20 may carry a control current between the stud welding gun 14 and the power control unit 12. The control current may energize components in the stud welding gun 14 that position a stud relative to the workpiece 16. These components, which are described below, may lift the stud during arcing and plunge the stud into the resulting pool of liquid metal, thereby securing the stud to the workpiece 16.

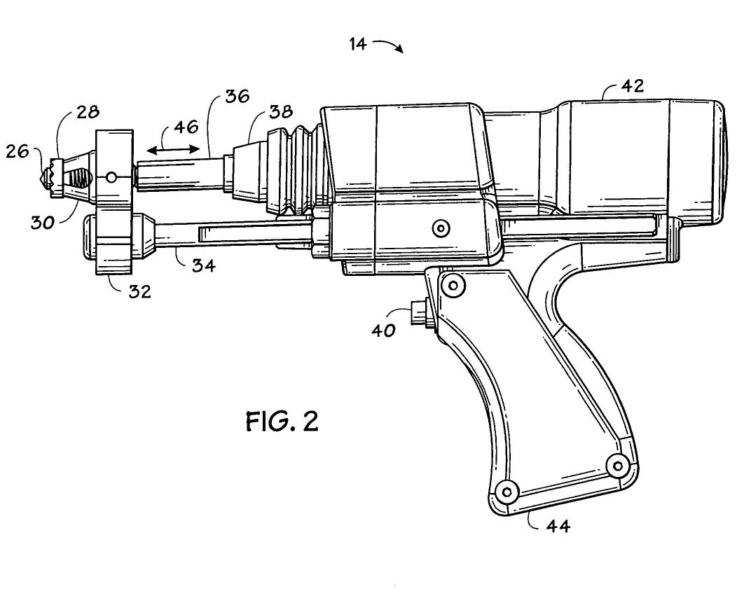

FIG. 2 depicts the exemplary stud welding gun 14 in greater detail. The present stud welding gun 14 may include a stud 26, a ferrule 28, a ferrule grip 30, a foot 32, legs 34, and a chuck adapter 38. Additionally, the exemplary stud welding gun 14 may include a trigger 40, a stud drive 42, and a handle 44. The stud drive may include components, e.g., a main spring and a solenoid, adapted to produce a linear displacement of the stud 26. The present stud welding gun 14 is a manual stud welding gun. Embodiments in accordance with the present technique may further include an automatic production gun, a positioning device, an automatic fastener loading system, and/or a factory automation system. The stud 26 may include conductive materials and have a generally cylindrical or otherwise elongated shape. Of course, the present technique is not limited to studs 26 with any particular shape. In some embodiments the stud 26 may include flux.

In the present stud welding gun 14, the ferrule 28 may be removably secured to the ferrule grip 30. The ferrule grip 30, in turn, may be removably secured to the foot 32, which may be held in spaced relation to the handle 44 by legs 34. In the present embodiment, the stud 26 is removably coupled to the chuck 36, which is removably coupled to the chuck adaptor 38. The stud drive 42 may connect to the chuck adaptor 38 and to the handle 44.

In operation, when the ferrule 28 is pressed against the workpiece 16, a compressive force may be transmitted from the handle 44, through the legs 34, into the foot 32 and through the ferrule grip 30 to the ferrule 28. The compressive force from the handle 44 may press the ferrule 28 against the workpiece 16, thereby, in some embodiments, stabilizing the stud welding gun 14 at a static location on the workpiece 16. The present ferrule grip 30 may be removed from the foot 32 and replaced with a different sized ferrule grip 30 to accommodate different sized ferrules 28.

Once the ferrule 28 is pressed against the workpiece 16, various moving parts may position the stud 26 relative to the workpiece 16. For instance, the stud drive 42 may linearly position the stud 26 relative to the workpiece 16, as is depicted by arrows 46. In embodiments where the stud drive 42 includes a solenoid and a main spring, a control current transmitted through the control cable 20 from the power control unit 12 may energize the solenoid. In these embodiments, the solenoid may compress the main spring 12 and lift the stud 26. When the solenoid is de-energized, the main spring may plunge the stud 26 back into the workpiece 16. Movement of the stud drive 42 may be transmitted to the stud 26 through the chuck 36 and the chuck adapter 38. In some embodiments, chuck 36 may be removed and replaced with different sized chucks 36 to accommodate different sized studs 26.

Several stages of an exemplary stud welding operation are depicted by FIGS. 3-6. As illustrated by FIG. 3, the stud 26 may be initially positioned at a discreet location on the workpiece 16. In some embodiments, the stud 26 is pressed against the workpiece 16 by slightly compressing the main spring in the stud drive 42. The ferrule 28 may also be pressed against the workpiece 16 in an area surrounding or near the stud 26. The present exemplary stud 26 includes a tip 48 that may contact the workpiece 16, a non-threaded portion 50, and a threaded portion 52. The exemplary stud 26 may be secured by the chuck 36.

Turning to FIG. 4, after positioning the stud 26 on or near the workpiece 16, welding may begin. In the present embodiment, a solenoid in the stud drive 42 may be energized, thereby compressing the main spring and lifting the chuck 36. As the chuck 36 lifts, the stud 26 may rise linearly from the workpiece 16, as depicted by arrow 54. Of course other embodiments may not employ these components to position the stud 26, or may not employ these components to position the stud 26 in this way, or may not include some or all of these components. For example, other embodiments may include some other type of electrode other than a stud 26. As the stud 26 is lifted, the stud 26 may slide within the ferrule 28, and the ferrule 28 may stay in contact with or near the workpiece 16. Alternatively, other embodiments may move the ferrule 28 or not include a ferrule 28, which is not to imply that other features discussed herein may not also be omitted in accordance with the present technique. Before, at approximately the same time, or after lifting 54 the stud 26, the welding system 10 may form an electric potential between the stud 26 and the workpiece 16 (hereinafter a source voltage). A welding current may flow to/from the power control unit 12, through the weld cable 18, through the stud 26 and into/from the workpiece 16 across an arc 56. In the present embodiment, the arc 56 heats the metal in the stud 26 and/or the workpiece 16 and causes localized melting. The ferrule 28 may confine the heat and liquid metal near the tip 48 of the stud 26. In the disclosed embodiments, if some of the metal bridges the gap between the stud 26 and the workpiece 16 creating a short circuit, then the power control unit 12 may sense one or more feedback parameters indicative of short circuit and respond by outputting a current surge or pulse to the stud welding gun 14. The current surge or pulse generally breaks up the metal bridge, thereby separating the stud 26 from the workpiece 16 to enable the arc 56 to reform and to continue the localized melting.

FIGS. 5 and 6 illustrate the completion of a successful stud welding operation. FIG. 5 depicts the re-application of the stud 26 to the workpiece 16. In the current embodiment, after a pool of molten metal 58 has been formed near the tip 48 of the stud 26, the stud drive 42 may plunge the stud 26 into the molten pool 58, as depicted by arrow 60. Finally, as depicted by FIG. 6, the molten pool 58 freezes, thereby forming a weld 62 between the stud 26 and the workpiece 16. At this point, the chuck 36 may be detached from the stud 26, and the ferrule 28 may be removed from the stud 26. The stud 26 may be generally permanently secured to the workpiece 16. Another stud 26 may be placed in the chuck 36, and the process depicted by FIGS. 3-6 may be repeated at another location on the workpiece 16.

As discussed above, the arc 56 may be short circuited during welding. The liquid metal 58 may splash up and bridge between the tip 48 and the workpiece 16. The bridging may short circuit the arc 56, which may lead to an incomplete weld. The resistance of the short circuit through the metal bridge may be much lower than the resistance of the air gap between the tip 48 and the workpiece 16. As a result, less electrical energy may be converted into heat and the temperature may drop. The lower temperatures may prematurely freeze the stud 26 to the workpiece 16 with an incomplete weld formed by the bridge of metal. However, as is explained below, certain embodiments of the present technique may disrupt such a short circuit and restore the arc 56. Indeed, some embodiments may disrupt the short circuit and restore the arc before the liquid metal freezes.

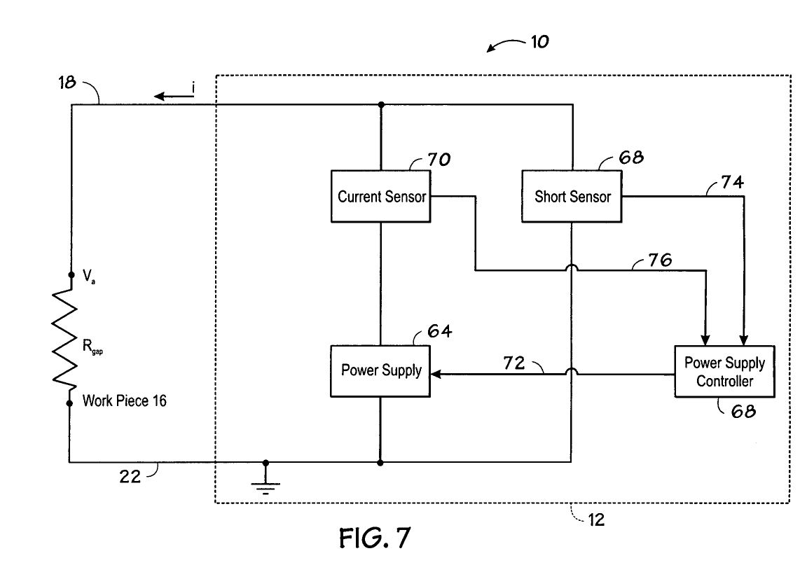

FIG. 7 is a diagrammatic representation of the welding system 10. The source voltage, i.e., the electric potential between stud 26 and the workpiece 16, is depicted by Vₐ and the voltage of the workpiece 16 is illustrated by a node labeled workpiece 16. The resistance between the stud 26 and the workpiece 16 is represented by a resistor labeled R_{gap}. The weld current through the weld cable 18 is labeled i. The power control unit 12 may include a power supply 64, a power supply controller 66, a short sensor 68, and a current sensor 70. While these components are depicted as part of the power control unit 12 in the present embodiment, they may be distributed throughout the welding system 10, such as partially or wholly within the stud welding gun 14, for example. Further, in certain embodiments, one or more of these components may be partially or entirely omitted or partially or entirely integrated into another of these components. The power supply 64 may be an inverter power supply having an inverter current regulator or some other form of power supply configured to deliver and/or regulate a weld current i, for example. In some embodiments, power supply controller 66 may include a microprocessor or other analog or digital circuit configured to control the operation of the power supply 64 and/or other components of the welding system 10. The power supply controller 66 may include or be part of an in situ or ex situ feed forward or feedback controller, for example. The short sensor 68 may be voltage sensor, an impedance sensor, an electromagnetic radiation sensor, a current sensor, a temperature sensor, or some other sensor configured to detect a short between the stud 26 and the workpiece 16. Current sensor 70 may include a hall effect sensor or some other sensor adapted to sense the magnitude and/or direction of the current i through the weld cable 18. In some embodiments, the current sensor 70 is also the short sensor 68.

As assembled in the current embodiment, the power supply controller 66 may communicatively couple to the power supply 64, which may be electrically coupled to the ground cable 22 and the weld cable 18. The current sensor 70 may be disposed in series between the power supply 64 and either the weld cable 18 or the ground cable 22, for example. The short sensor 68 may be electrically coupled to the weld cable 18 and the ground cable 22, in parallel with R_{gap} and the power supply 64. Alternatively, the short sensor 68 may be disposed elsewhere within the welding system 10, depending on the type of short sensor 68. The current sensor 70, short sensor 68, and power supply 64 may communicatively couple to the power supply controller 66.

In operation, the power supply controller 66 may control the operation of part or all of the welding system 10. For example, the power supply controller 66 may receive a current signal 76 from the current sensor 70. Based on that signal 76 and/or others, the power supply controller 66 may exercise feedback control over the power supply 64 by transmitting power control signals 72 to the power supply 64. Additionally, in some embodiments, the power supply controller 66 may transmit positional control signals through the control cable 20 to the stud drive 42, thereby controlling the position of the stud 26.

In some embodiments, the welding system 10 may detect a short circuit around an arc 56 and disrupt the short circuit. The short sensor 68 may sense Vₐ, a change in Vₐ, and/or some other parameter indicative of shorting around the arc 56, such as a change in, or amount of, impedance, temperature, current, mechanical stress, mechanical strain, sound, and/or electromagnetic emission from an arc 56, for example. For instance, the short sensor 68 may measure a drop in Vₐ and output a short circuit warning signal 74 in response. The power supply controller 66 may receive the short circuit warning signal 74, which may be analog or digital. It may directly indicate a short circuit and/or it may carry information that facilitates determining if a short circuit has occurred, has likely occurred, will occur, and/or is likely to occur.

When a short circuit warning signal 74 is received, the power supply controller 66 may output a short-disrupting control signal. For instance, the power supply controller 66 may output a short-disrupting power control signal 72, which may be received by the power supply 64. The power supply 64 may respond to the signal 72 by increasing or changing current i, voltage Vₐ, or some other parameter that may tend to disrupt the short circuit and/or restore the arc 56. A change in current i or Vₐ may be in the form of a pulse, a series of pulses, a step up, an oscillation, or some other wave form, for instance. Alternatively, the short-disrupting control signal may be received by some other device adapted to disrupt a short circuit. For example, the stud drive 42 or some other component may introduce a mechanical disruption of the short by, for instance, moving the stud 26.

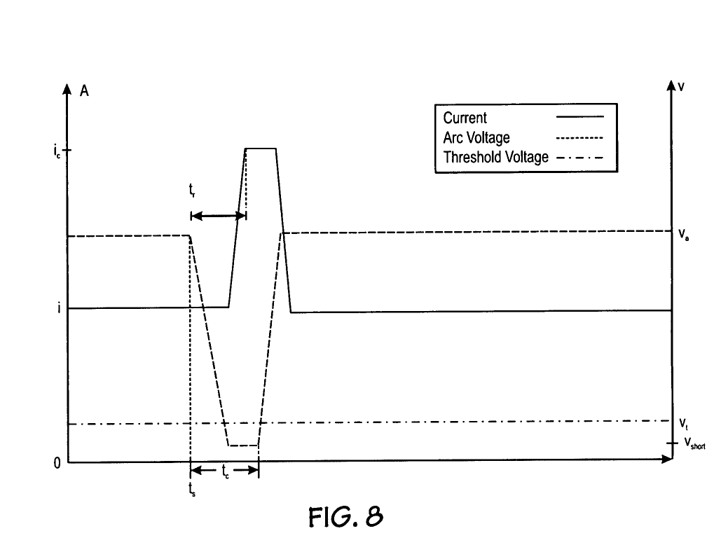

FIG. 8 is a graph depicting exemplary weld current i and arc voltage Vₐ traces while the welding system 10 drives an arc 56. In FIG. 8, a short circuit forms between the stud 26 and the workpiece 16 at time tₛ. As the resistance of liquid metal forming the short may be much lower than the resistance of air between the stud 26 and the workpiece 16, R_{gap} may drop, and Vₐ may drop to value Vₛₕₒᵣₜ. The short sensor 68 may detect the drop in Vₐ and signal 74 the power supply controller 66, for instance, when Vₐ drops below a threshold voltage Vₜ. Vₜ may be less than 20 volts, 15 volts, 10 volts, 5 volts, or some other value selected to indicate a short circuiting of the arc 56, for example. In response to Vₐ crossing Vₜ, the power supply controller 66 may transmit the increase current power control signal 72 to the power supply 64, which may result in an increase in the current i to a clearing current i_{c}. In some embodiments, the increase in current to i_{c} may open the short and restore the arc 56. The increase from i to i_{c} may be greater than 200% of i, 150% of i, 100% of i, 80% of i, 60% of i, 50% of i, 40% of i, 30% of i, 20% of i, or 10% of i, for example. In FIG. 8, tᵣ indicates the response time, which is the time at which the disruption to the short is applied, and t_{c} depicts the time at which the short is cleared. The clearance time t_{c} and/or response time tᵣ may be less than 20 milliseconds, 15 milliseconds, 10 milliseconds, 8 milliseconds, 7 milliseconds, 6 milliseconds, 5 milliseconds, 4 milliseconds, 3 milliseconds, or 2 milliseconds, for example.

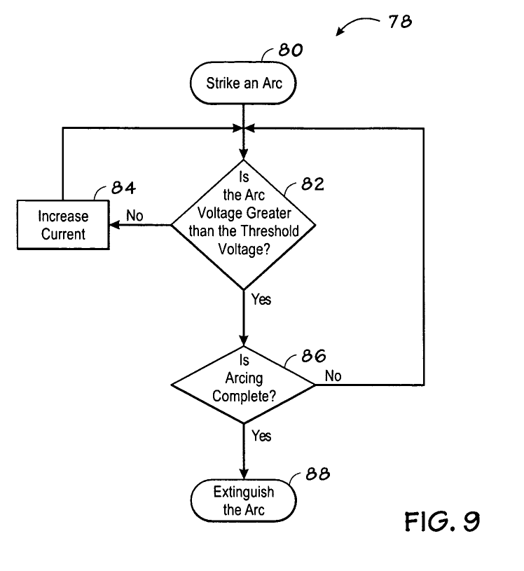

FIG. 9 depicts an exemplary welding process 78, which may be performed by the welding system 10 or other systems. The exemplary welding process 78 begins by striking an arc as depicted by block 80. Next, it is determined if the arc voltage Vₐ is greater than the threshold voltage Vₜ, as depicted by block 82. If the arc voltage Vₐ is not greater than the threshold voltage, then the current is increased, as depicted by block 84. In other words, the process 78 provides response to feedback of Vₐ less than the threshold voltage, which indicates a short circuit (e.g., bridged metal) between the stud welding gun 14 and the workpiece 16. The current clears the short circuit. As discussed above, the increase in current may include a variety of waveforms, such as a step, pulse, and/or oscillation, for example. If the arc voltage is greater than the threshold voltage, then arcing continues until the welding system determines that arcing is complete, as depicted by block 86. In some embodiments, arcing may be complete within less than 5 seconds, 4 seconds, 3 seconds, 2 seconds, 1.5 seconds, 1 seconds, and/or 0.5 seconds, for example. If arcing is not complete, then the steps depicted by blocks 82, 86, and possibly 84 are repeated. That is, welding may continue while monitoring for short circuits. If arcing is complete, then the arc is extinguished, as depicted by block 88.

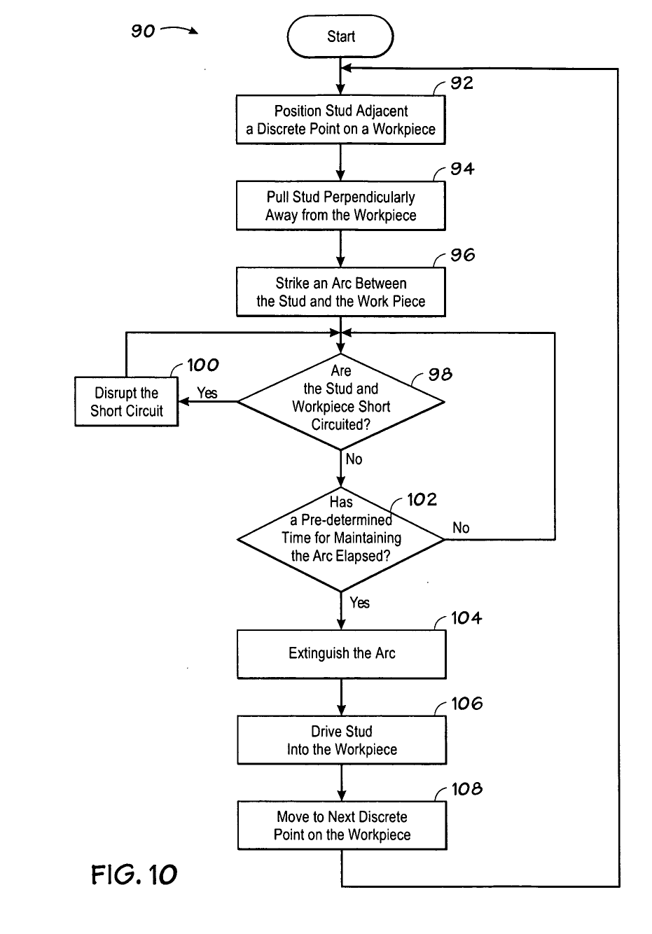

FIG. 10 depicts another exemplary welding process 90. The exemplary welding process 90 begins by positioning a stud 26 adjacent a discreet point on a workpiece 16, as depicted by block 92. Next, the stud 26 may be pulled perpendicularly away from the workpiece 16, as depicted by block 94, and an arc 56 may be struck between the stud 26 and the workpiece 16, as depicted by block 96. The stud 26 may be perpendicular to, or in contact with, a static location on the workpiece 16 during all or part of this welding process 90. Then, it is determined if the stud 26 and the workpiece 16 are short circuited (e.g., by bridged metal), as depicted by block 98. If the stud 26 and the workpiece 16 are short circuited (e.g., by bridged metal), then the short circuit is disrupted as depicted by block 100. As discussed above, disruption of the short circuit may be accomplished by changing a variety of parameters, such as current, voltage, and/or position. For example, a current pulse or surge may be sent through the bridged metal and generally reestablish the gap. Otherwise, it is determined if a predetermined time for maintaining the arc 56 has elapsed, as depicted by block 102. If a predetermined time for maintaining the arc 56 has not elapsed, then the steps 98, 102 and possibly 100 are repeated. If on the other hand, a predetermined time for maintaining the arc 56 has elapsed, then the arc 56 is extinguished, as depicted by block 104. Next, the stud 26 is driven into the workpiece 16, as depicted by block 106. In some embodiments, the arc may be extinguished, as depicted by block 104, by driving the stud into the workpiece, as depicted by block 106. Once the stud 26 is secured to the workpiece 16, the stud gun 14 may be moved to another next discreet point on the workpiece 16, as depicted by block 108. Of course, the present technique is not limited to this sequence of steps, and some of these steps may be omitted, performed in a different sequence, and/or performed concurrently.

1. A system, comprising:
a short circuit sensor configured to transmit a first signal indicative of a short circuit between a workpiece and a stud; and
a stud welding controller communicatively coupled to the short circuit sensor, wherein the stud welding controller is configured to transmit an increase-current control signal to a power supply in response to the first signal.

2. The system of claim 1, wherein the stud welding controller is configured to produce a stud-lifting control signal and a stud-plunging control signal.

3. The system of claim 2, wherein the stud welding controller is configured to not transmit the increase-current control signal before producing the stud-lifting control signal or after producing the stud-plunging control signal.

4. The system of claim 1, wherein the short circuit sensor is a voltage sensor.

5. The system of claim 1, wherein the stud welding controller is configured to transmit an increase-current control signal within 4 milliseconds of receiving the first signal.

6. The system of claim 1, wherein the stud welding controller is configured to transmit an increase-current control signal that corresponds to a greater than 30% increase in a welding current.

7. The system of claim 1, comprising a current sensor configured to transmit a second signal representative of a welding current to the stud welding controller, wherein the stud welding controller is configured to exercise feedback control of the welding current based on the second signal.

8. The system of claim 1, wherein the stud welding controller comprises a microprocessor.

9. The system of claim 1, comprising a power supply having an inverter current regulator.

10. The system of claim 1, comprising at least one of the following: a stud welding gun, a power supply, an automatic stud loading system, a stud welding power control unit, an automatic stud welding gun positioning device, a factory automation system configured to position the stud welding gun on a workpiece, a weld cable, a control cable, a workpiece, or any combination thereof.

11. A system, comprising:
a welding controller configured to detect a first signal indicative of a short circuit between an electrode and a workpiece and, when the first signal is detected, output a second signal adapted to trigger a disruption of the short circuit.

12. The system of claim 11, wherein the welding controller comprises a stud-welding controller and the electrode comprises a stud.

13. The system of claim 11, wherein the welding controller is configured to output the second signal after detecting bridged material between the electrode and the workpiece and before the bridged material substantially solidifies.

14. The system of claim 11, comprising an impedance sensor configured to output the first signal based at least in part on an impedance through the workpiece and the electrode.

15. The system of claim 11, comprising a power supply configured to receive the second signal and increase a weld current through the electrode in response to the second signal, wherein the welding controller is configured to increase the weld current by greater than 20% within 8 milliseconds of the welding controller detecting the first signal.

16. A method, comprising:
providing a stud welding control circuit configured to identify a short circuiting of an arc between a stud and a workpiece and restore the arc when short circuiting is identified.

17. The method of claim 16, wherein the stud welding control circuit is configured to restore the arc within 5 milliseconds of the short circuiting.

18. The method of claim 16, comprising providing a power supply, wherein the stud welding control circuit is configured to restore the arc by, at least in part, signaling the power supply to increase an electric current through the stud and the workpiece.

19. The method of claim 19, wherein the stud welding control circuit comprises a voltage sensor that outputs a signal indicative of the short circuiting of the arc.

20. The method of claim 20, comprising providing at least one of the following: a stud welding gun, a power supply, a stud welding power control unit, an automatic stud loading system, an automatic stud welding gun positioning device, a factory automation system configured to position the stud welding gun on a workpiece, a weld cable, a control cable, a workpiece, or any combination thereof.
